(19) United States
(12) Patent Application Publication
(10) Pub. No.: US 2023/0057329 A1
(43) Pub. Date: Feb. 23, 2023

(54) NUMERICALLY MORE STABLE TRAINING OF A NEURAL NETWORK ON TRAINING MEASURED DATA PROVIDED AS A POINT CLOUD

(71) Applicant: Robert Bosch GmbH, Stuttgart (DE)

(72) Inventors: Andrej Junginger, Stuttgart (DE); Thilo Strauss, Ludwigsburg (DE)

(21) Appl. No.: 17/820,889

(22) Filed: Aug. 19, 2022

(30) Foreign Application Priority Data
Aug. 23, 2021 (DE) 10 2021 209 210.1

(51) Int. Cl. G06N 3/08; G06K 9/62

(52) U.S. Cl. CPC G06N 3/08; G06K 9/6256; G06K 9/6261; G06K 9/6268

(57) ABSTRACT

A method for monitored training of a neural network. In the method, training examples including training measured data and associated training output variables are provided; a spatial region, which contains at least a part of the locations indicated by the training measured data of a training example, is subdivided into a grid made up of adjoining cells; for each cell, values of the measured variables contained in the training measured data for all locations in this cell are aggregated to form values of the measured variables which relate to this cell; these aggregated values of the measured variables are mapped by the neural network on one or multiple output variables; deviations of these output variables from the training output variables are assessed using a predefined cost function; parameters of the neural network are optimized.

### CROSS REFERENCE

The present application claims the benefit under 35 U.S.C. § 119 of German Patent Application No. DE 10 2021 209 210.1 filed on Aug. 23, 2021, which is expressly incorporated herein by reference in its entirety.

### FIELD

The present invention relates to the training of neural networks, which may be used, for example, for evaluating observations of vehicle surroundings with the aid of radar, LIDAR, and/or ultrasound.

### BACKGROUND INFORMATION

In order that a vehicle may move in an at least semiautomated manner in road traffic, it is necessary to detect the surroundings of the vehicle and initiate countermeasures if a collision with an object in the surroundings of the vehicle is imminent. The creation of a surroundings representation and localization are also required for safe automated driving.

The detection of objects with the aid of radar is independent of the light conditions and is also possible, for example, at night at greater distance, without the oncoming traffic being blinded by high beams. Furthermore, the distance and velocity of objects result directly from the radar data. These pieces of information are important for the assessment of whether a collision may occur with the objects. However, it is not directly recognizable from radar signals which type of object it is.

In addition to the calculation of attributes from the digital signal processing, neural networks are increasingly used to classify objects on the basis of observations of the vehicle surroundings produced using radar. German Patent Application No DE 10 2019 220 069 A1 describes an exemplary method.

### SUMMARY

According to the present invention, a method is provided for the monitored training of a neural network. This neural network maps measured data on one or multiple output variables. The measured data assign values of one or multiple measured variables to locations in the two-dimensional or three-dimensional space, which do not have to be coherent. The measured data may thus be considered as a point cloud distributed in space including scalar or vectorial values of measured variables.

According to an example embodiment of the present invention, training examples from training measured data and associated training output variables are provided for the training. A training example thus combines a point cloud made up of measured data, which are each assigned to locations in the space, with the learning output variables which the neural network is ideally to supply in the trained state when the training measured data from this point cloud are supplied to it.

A spatial region which contains at least a part of the locations indicated by the training measured data of a training example is divided into a grid made of adjoining cells. For each cell, the values of the measured variables contained in the training measured data of the training example for all locations in this cell are aggregated to form values of the measured variables which relate to this cell. That is to say, each location which is indicated in the training measured data of the training example is checked as to whether it is in a specific cell of the grid and if this is the case, the values associated with this location of the one or multiple measured variables take part in the aggregation. For cells in which no locations included in the training measured data fall, the result of the aggregation remains zero in each case with respect to the one or multiple measured variables.

The aggregated values of the measured variables assigned to the cells of the grid are mapped by the neural network on one or multiple output variables. In particular the reference to the cells of the grid enables the values to be summarized in a matrix or a tensor, to supply them in this form to the neural network. Most neural networks expect an input as a matrix or tensor and cannot directly process measured data which are provided as a point cloud.

Said aggregated values of the measured variables are mapped by the neural network on one or multiple output variables. Deviations of these output variables from the training output variables are assessed using a predefined cost function, which the feedback supplies for the training. In contrast to the conventional training of neural networks, this cost function is composed in weighted form from contributions of individual cells of the grid, weight α of each contribution being a function of the occupancy of the corresponding cell of the locations contained in the training measured data of the training example.

In the case of a two-dimensional grid including indices i and j, for example, the cost function may have the form

$$L = {\sum }_{i , j} f ( {G}_{NN} ( i , j ) , {G}_{G T} ) \cdot α ( i , j )$$

Herein, G_{NN}(i,j) is the contribution of a grid cell including indices i and j to the result which the neural network supplies as a whole. G_{GT} denotes the “ground truth,” thus the training output variables which the neural network is nominally supposed to supply. Function f measures to what extent contribution G_{NN}(i,j) deviates from its setpoint in consideration of “Ground Truth” G_{GT}. Function f may indicate, for example, a mean square error or an L1 norm.

Parameters which characterize the behavior of the neural network are optimized with the goal that upon further processing of training examples, the assessment by the cost function is expected to improve.

The term “expected” is to be understood in this context in such a way that iterative numeric optimization algorithms select the new values of the parameters for the next iteration on the basis of the prior history of iterations in the expectation that the assessment by the cost function improves in this way. However, this expectation does not have to be met for each iteration, i.e., an iteration may also prove to be a “step back.” The optimization algorithm may also use feedback of this type, however, to thus ultimately arrive at values of the parameters for which the assessment by the cost function improves.

According to an example embodiment of the present invention, in the transfer of the training measured data provided as a point cloud into aggregated measured variables, which are each assigned to cells of the grid, it is decisively dependent on the mesh width of the grid for how many cells the aggregation results in values different from zero at all and for how many cells it stops at zero. If, in an extreme example, the spatial region were only divided into four quadrants, locations would be located in each of these quadrants to which the training measured data assigns values of measured variables. If, in the other extreme, the spatial region were divided into cells of 1 cm² (or in the three-dimensional case 1 cm³), the aggregation would thus only be not equal to zero for as many cells of the grid as there are locations in the point cloud of the corresponding training example. This would be opposed by an overwhelming majority of cells which are not occupied by locations from the training example and for which the result of the aggregation is therefore zero.

It has been recognized that the percentage of the cells of the grid for which the result of the aggregation is zero has an effect on the numeric stability of the training. If this proportion exceeds a certain critical value, a trivial output of exclusively zeros as output variables has heretofore been assessed very favorably by the cost function. The small error which thus results, that the few aggregations different from zero “are swept under the carpet,” is acceptable from the viewpoint of the cost function. This is somewhat similar to the parking situation in inner cities having compulsory tickets for parking: if only a negligibly small proportion of the parking areas are monitored by the traffic supervision per day and if a warning fine is levied if the ticket for parking is absent, it is more cost-effective and convenient on average not to find suitable coins each day and feed them into the parking ticket machine, but rather on average to pay a €5 warning fine via debit every three weeks.

The weighting of the cost function starts precisely at this point. It ensures that cells of the grid which are not occupied by locations of the training example are given a significantly weaker voice than cells of the grid which are occupied by multiple or even many of these locations. The trivial solution, to set all output variables to zero, is thus no longer the most favorable one from the viewpoint of the cost function. To obtain a good assessment by the cost function, the neural network is thus not left with any other choice than to analyze in detail the aggregated values of the measured variables for those cells which are occupied by locations of the training example. In the example described of the parking situation, this corresponds to a significant increase of the threatened sanction for violations. If a €5 warning fine no longer has to be paid on average every three weeks, but rather a time-consuming trip to the towing company in the neighboring city is necessary and the vehicle has to be released there for €300, completely dispensing with tickets for parking is suddenly no longer the most cost-effective solution. Instead, the learning process will very soon converge on the solution of acquiring suitable coins in the evening and feeding them into the machine in the morning.

In one advantageous embodiment of the present invention, weight α of the contribution of at least one cell to the cost function
is set at a first positive value a when the training measured data of the training example do not indicate a location in this cell, and
is set to a second, higher positive value b when the training measured data of the training example indicate at least one location in this cell.

The number of the cells in which no location indicated in the measured data is located in the present training example then does not remain completely unconsidered. However, the rare cells in which according to the present example a location indicated in the measured data is located are given significantly more importance.

In this case in particular, for example, second positive value b may be between eight times and twenty times first positive value a. In particular, experiments of the inventors have shown that significantly more stable training processes and a significantly better performance of the ultimately trained neural network on test or validation data could be achieved using a value b which was approximately ten times value a. In the extreme case, the neural network could only take into consideration the cells occupied with locations of measured data of the training example in the training due to the introduction of weight α.

In another advantageous example embodiment of the present invention, a distribution of weights α within the grid is selected in such a way that cells, within which the training measured data of the training example do not indicate a location, overall supply the same contribution to the cost function as cells within which the training measured data of the training example indicate at least one location. In this way, the weighting may be normed in particular, for example, over a plurality of training examples. The distribution of weights α may thus be adapted for each individual training example. This is particularly advantageous, for example, in the processing of radar or LIDAR reflections as measured data. Depending on the perspective from which an object is illuminated using corresponding query radiation, the resulting reflections may be distributed over the entire spatial region or may only be concentrated in a small part of the spatial region.

In another advantageous example embodiment of the present invention, at least one weight α is also optimized with the goal that the assessment by the cost function is expected to improve upon further processing of training measured data. This optimization may be interlinked in particular, for example, with the optimization of the parameters of the neural network. These parameters in particular include weights, using which inputs, which are supplied to a neuron or another processing unit, are offset with activations of this neuron or this processing unit. Due to this relationship of the parameters to the weights α, the assessment of the cost function may not only be propagated back well to changes of the parameters of the neural network, but also to changes of weights α.

As explained above, weights α in the cost function compensate for the effect that a reduction of the mesh width of the grid of those cells of the grid in which, according to the present training example, locations of training measured data are located pushes the cost function into irrelevance. The mesh width thus becomes a degree of freedom in the literal meaning again in that it may be optimized freely with regard to the best possible performance of the neural network.

Therefore, in a further advantageous example embodiment of the present invention, the training is repeated for multiple subdivisions of the spatial region into grids having different mesh widths. That mesh width for which the training converges on the best assessment by the cost function is set as the optimum mesh width for the live operation of the neural network.

Training measured data including measured variables which characterize reflections of radar radiation, laser radiation, and/or ultrasonic waves at locations in the space may particularly advantageously be selected. Training examples including measured data obtained in this way very frequently contain point clouds which only fill up a small part of the space and, upon the transfer into the grid, generate many cells in each of which the aggregation is zero.

One advantageous application for neural networks which may be trained in the described manner is the transfer of measured data from a first measuring configuration to a second measuring configuration. Already existing measured data may thus be mapped on those measured data which would result if the sensors used had been installed differently.

Therefore, in one advantageous example embodiment of the present invention, training measured data are selected which were obtained by observing a scenery using a first measuring setup and/or from a first perspective. At the same time, training output variables are selected which were obtained by observing the same scenery using a second measuring setup and/or from a second perspective.

Another advantageous application is the generation of new synthetic measured data for the already existing measuring configuration. For example, fluctuations may be simulated in this way, which result in the case of successively recorded radar measurements of the same scenery using the same measuring configuration.

In another advantageous example embodiment of the present invention, training measured data and training output variables are therefore selected which were obtained by observing a scenery using the same measuring setup and/or from the same perspective.

Specifically in these applications, in which new measured data are to be generated, the cost function may be expressed particularly simply in contributions of individual cells of the grid. The output variable may initially be expressed in particular as a new grid including values which have the same dimension as the grid originally supplied to the neural network. A point cloud of the new measured data may then be sampled from the new grid, for example. “Deficiencies” of the new measured data which are “reprimanded” by the cost function may then be traced back directly to certain cells in the originally supplied grid.

In another advantageous example embodiment of the present invention, training output variables are selected which include classification scores of the training input variables with respect to one or multiple classes of a predefined classification. This is one of the most important applications of neural networks, in particular for driving assistance systems and systems for at least semiautomated driving.

As explained above, the above-described training improves the performance of the neural network in the later live operation. The present invention therefore also relates to a further method.

In this method, a neural network is trained using the above-described method. Measured data, which were recorded using at least one sensor carried along by a vehicle, are then supplied to the trained neural network. An activation signal is ascertained from the output variables supplied by the neural network. The vehicle may then be activated using the activation signal.

The probability that the reaction of the vehicle triggered by the activation signal is suitable for the traffic situation detected by the at least one sensor is then increased due to the performance of the neural network improved by the novel training.

The methods may in particular be entirely or partially computer-implemented. The present invention therefore also relates to a computer program including machine-readable instructions which, when they are executed on one or multiple computers, prompt the computer or computers to carry out one of the described methods. Control units for vehicles and embedded systems for technical devices which are also capable of executing machine-readable instructions are also to be considered computers in this meaning.

The present invention also relates to a machine-readable data medium and/or a download product including the computer program. A download product is a digital product transferable via a data network, i.e., downloadable by a user of the data network, which may be sold, for example, in an online shop for immediate download.

Furthermore, a computer may be equipped with the computer program, the machine-readable data medium, or the download product.

Further measures improving the present invention are described in greater detail hereinafter together with the description of the preferred exemplary embodiments of the present invention on the basis of figures.

### BRIEF DESCRIPTION OF EXAMPLE EMBODIMENTS

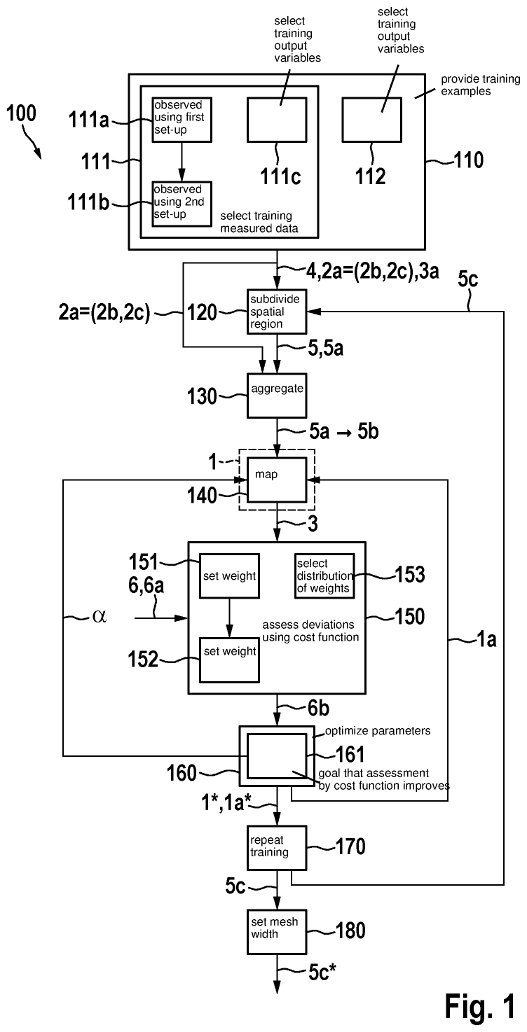

FIG. 1 shows an exemplary embodiment of method 100 for training a neural network 1.

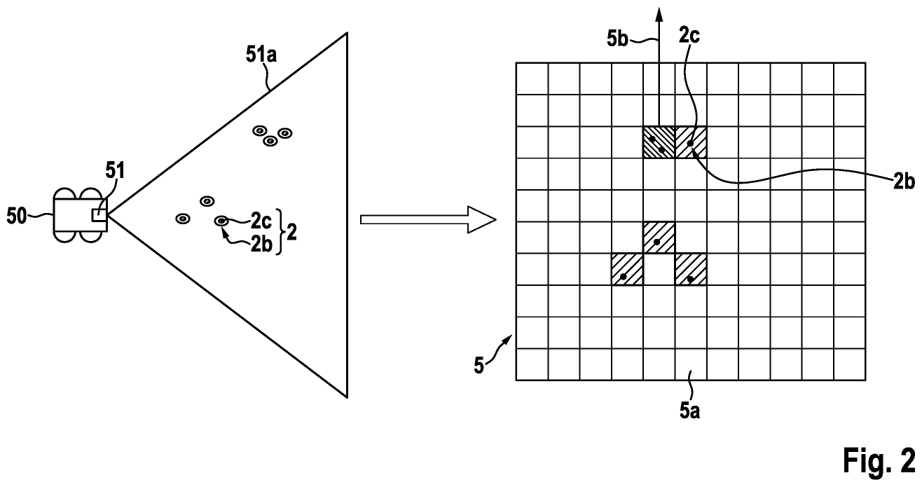

FIG. 2 shows a representation of the transfer of measured data 2 provided as a point cloud into a grid 5.

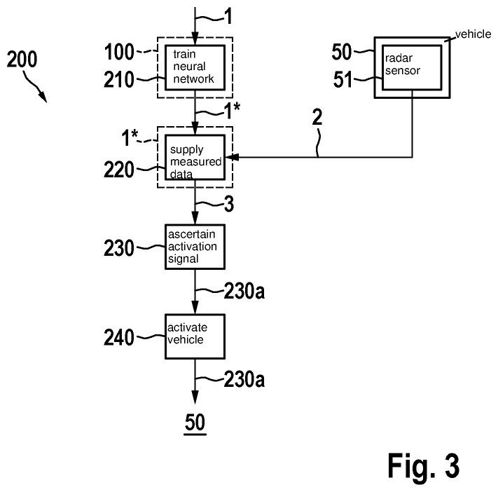

FIG. 3 shows an exemplary embodiment of method 200 including the complete action chain up to activation of a vehicle 50.

### DETAILED DESCRIPTION OF EXAMPLE EMBODIMENTS

FIG. 1 is a schematic flowchart of an exemplary embodiment of method 100 for training a neural network 1. Neural network 1 maps measured data 2 on one or multiple output variables 3. These measured data 2 assign values 2c of one or multiple measured variables to locations 2b in the two-dimensional or three-dimensional space.

In step 110, training examples 4 made up of training measured data 2a and associated training output variables 3a are provided. Training measured data 2a each include values 2c of measured variables which are assigned to locations 2b.

According to block 111, in particular, for example, training measured data 2a including measured variables 2c are selected, which characterize reflections of radar radiation, laser radiation, and/or ultrasonic waves at locations 2b in the space.

According to block 111a, in particular, for example, training measured data 2a may be selected which were obtained by observation of a scenery using a first measuring setup and/or from a first perspective. Then, according to block 111b, training output variables 3a may be selected, which were obtained by observation of the same scenery using a second measuring setup and/or from a second perspective.

According to block 111c, in particular, for example, training output variables 3a may be selected which were obtained by observation of a scenery using the same measuring setup and/or from the same perspective.

According to block 112, in particular, for example, training output variables 3a may be selected which include classification scores of training input variables 2a with respect to one or multiple classes of a predefined classification.

In step 120, the spatial region which contains at least a part of locations 2b indicated by training measured data 2a of a training example 4 is subdivided into a grid 5 made up of adjoining cells 5a.

In step 130, for each cell 5a, values 2c of measured variables contained in training measured data 2a of training example 4 for all locations 2b in this cell 5a are aggregated to form values 5b of the measured variables which relate to this cell 5a. This is explained in greater detail in FIG. 2.

In step 140, these aggregated values 5b of the measured variables are mapped by neural network 1 on one or multiple output variables 3.

In step 150, deviations of these output variables 3 from training output variables 3a are assessed using a predefined cost function 6, so that an assessment 6b results. This assessment 6b is composed in weighted form of contributions 6a of individual cells 5a of grid 5. Weight α of each contribution 6a is dependent on the occupancy of corresponding cell 5a with locations 2a contained in training measured data 2a of training example 4.

According to block 151, weight α of contribution 6a of at least one cell 5a to cost function 5 may be set to a first positive value a if training measured data 2a of training example 4 do not indicate a location 2b in this cell 5a. According to block 152, this weight α may be set to a second, higher positive value b if training measured data 2a of training example 4 indicate at least one location 2b in this cell 5a.

According to block 153, a distribution of weights α within grid 5 may be selected in such a way that cells 5a, within which training measured data 2a of training example 4 do not indicate a location 2b, overall provide the same contribution to cost function 5 as cells 5a, within which training measured data 2a of training example 4 indicate at least one location 2b. For example, first positive value a may be set to a=1−N_{2b=0}, N_{2b=0} being the number of those cells 5a in which no location 2b indicated by measured data 2a of training example 4 falls. Second positive value b may then be set to b=1−N_{2b>0}, N_{2b>0} being the number of those cells 5a in which at least one location 2b indicated by measured data 2a of training example 4 falls.

In step 160, parameters la, which characterize the behavior of neural network 1, are optimized with the goal that upon further processing of training examples 4, assessment 6b by cost function 6 is expected to improve. The finished trained state of the parameters is identified by reference numeral 1a*. These parameters 1a* characterize the behavior of finished trained neural network 1*.

According to block 161, in this case at least one weight α may also be optimized with the goal that upon further processing of training measured data 2a, assessment 6b by cost function 6 is expected to improve.

In step 170, the training is repeated for multiple subdivisions of the spatial region into grids 5 having different mesh widths 5c.

In step 180, that mesh width 5c for which the training converges on best assessment 6b by cost function 6 is set as optimal mesh width 5c* for the live operation of neural network 1.

FIG. 2 illustrates the transfer of measured data 2 provided as a point cloud into a grid 5. In this example, measured data 2 are recorded using a radar sensor 51, which is carried along by a vehicle 50. Radar sensor 51 detects radar reflections having measured variables 2c, which come from locations 2b, in its detection area 51a.

If a spatial region that contains at least a part of detection area 51 is divided into a grid 5 including cells 5a, a location 2b from which a radar reflection comes falls in each of some cells 5a. In the example shown in FIG. 2, two locations 2b, from each of which a radar reflection comes, fall in one cell 5a. For each cell 5a, an aggregated value 5b is formed from measured variables 2c for all radar reflections from locations 2b, in particular cell 5a. This aggregated value 5b is zero for most cells 5a because of a lack of locations 2b of radar reflections located therein. The weighting in cost function 6 according to above-described method 100 begins here.

FIG. 3 is a schematic flowchart of an exemplary embodiment of method 200 including the complete action chain up to the activation of vehicle 50.

In step 210, a neural network 1 is trained using above-described method 100.

In step 220, measured data 2 are supplied to trained neural network 1*, which were recorded using at least one sensor 51 carried along by a vehicle 50.

In step 230, an activation signal 230a is ascertained from output variables 3 supplied by neural network 1*.

In step 240, vehicle 50 is activated using this activation signal 230a.

What is claimed is:

1. A method for monitored training of a neural network, which maps measured data on one or multiple output variables, the measured data assigning values of one or multiple measured variables to locations in the two-dimensional or three-dimensional space, the method comprising the following steps:
providing training examples made up of training measured data and associated training output variables;
subdividing a spatial region, which contains at least a portion of the locations indicated by the training measured data of a training example, into a grid made up of adjoining cells;
aggregating, for each cell of the adjoining cells, the values of the measured variables contained in the training measured data of the training example for all locations in the cell, to form values of the measured variables which relate to the cell;
mapping the aggregated values of the measured variables, by the neural network, on one or multiple output variables;
assessing deviations of the output variables from the training output variables using a predefined cost function, which is composed in weighted form of contributions of individual cells of the grid, the weight of each contribution being a function of an occupancy of the corresponding cell with locations contained in the training measured data of the training example; and
optimizing parameters, which characterize a behavior of the neural network, with a goal that upon further processing of training examples, the assessment by the cost function is expected to improve.

2. The method as recited in claim 1, wherein the weight of the contribution of at least one cell to the cost function:
is set to a first positive value when the training measured data of the training example do not indicate a location in the at least one cell, and
is set to a second, higher positive value when the training measured data of the training example indicate at least one location in the at least one cell.

3. The method as recited in claim 2, wherein the second positive value is between eight times and twenty times the first positive value.

4. The method as recited in claim 1, wherein a distribution of the weights within the grid is selected in such a way that cells, within which the training measured data of the training example do not indicate a location, overall supply the same contribution to the cost function as cells, within which the training measured data of the training example indicate at least one location.

5. The method as recited in claim 1, wherein at least one weight is also optimized with a goal that upon further processing of training measured data, the assessment by the cost function is expected to improve.

6. The method as recited in claim 1, wherein:
the training is repeated for multiple subdivisions of the spatial region into grids having different mesh widths; and
that mesh width, for which the training converges on a best assessment by the cost function, is set as an optimum mesh width for live operation of the neural network.

7. The method as recited in claim 1, wherein training measured data including measured variables, which characterize reflections of radar radiation, laser radiation, and/or ultrasonic waves at locations in the space, are selected.

8. The method as recited in claim 7, wherein
the training measured data are obtained by observation of a scenery using a first measuring setup and/or from a first perspective; and
the training output variables are obtained by observation of the same scenery using a second measuring setup and/or from a second perspective.

9. The method as recited in claim 7, wherein the training measured data and the training output variables are obtained by observation of a scenery using the same measuring setup and/or from the same perspective.

10. The method as recited in claim 1, wherein the training output variables contain classification scores of the training input variables with respect to one or multiple classes of a predefined classification.

11. A method, comprising the following steps:
training a neural network which maps measured data on one or multiple output variables, the measured data assigning values of one or multiple measured variables to locations in the two-dimensional or three-dimensional space, the training including:
providing training examples made up of training measured data and associated training output variables,
subdividing a spatial region, which contains at least a portion of the locations indicated by the training measured data of a training example, into a grid made up of adjoining cells,
aggregating, for each cell of the adjoining cells, the values of the measured variables contained in the training measured data of the training example for all locations in the cell, to form values of the measured variables which relate to the cell,
mapping the aggregated values of the measured variables, by the neural network, on one or multiple output variables,
assessing deviations of the output variables from the training output variables using a predefined cost function, which is composed in weighted form of contributions of individual cells of the grid, the weight of each contribution being a function of an occupancy of the corresponding cell with locations contained in the training measured data of the training example, and
optimizing parameters, which characterize a behavior of the neural network, with a goal that upon further processing of training examples, the assessment by the cost function is expected to improve;
supplying measured data, to the trained neural network, which are recorded using at least one sensor carried along by a vehicle; and
ascertaining an activation signal from the output variables supplied by the neural network.

12. The method as recited in claim 11, wherein the vehicle is additionally activated using the activation signal.

13. A non-transitory machine-readable data medium on which is stored a computer program configured for monitored training of a neural network which maps measured data on one or multiple output variables, the measured data assigning values of one or multiple measured variables to locations in the two-dimensional or three-dimensional space, the computer program, when executed by one or multiple computers, causing the one or multiple computers to perform the following steps:
providing training examples made up of training measured data and associated training output variables;
subdividing a spatial region, which contains at least a portion of the locations indicated by the training measured data of a training example, into a grid made up of adjoining cells;
aggregating, for each cell of the adjoining cells, the values of the measured variables contained in the training measured data of the training example for all locations in the cell, to form values of the measured variables which relate to the cell;
mapping the aggregated values of the measured variables, by the neural network, on one or multiple output variables;
assessing deviations of the output variables from the training output variables using a predefined cost function, which is composed in weighted form of contributions of individual cells of the grid, the weight of each contribution being a function of an occupancy of the corresponding cell with locations contained in the training measured data of the training example; and
optimizing parameters, which characterize a behavior of the neural network, with a goal that upon further processing of training examples, the assessment by the cost function is expected to improve.

14. One or multiple computers configured for monitored training of a neural network which maps measured data on one or multiple output variables, the measured data assigning values of one or multiple measured variables to locations in the two-dimensional or three-dimensional space, the one or multiple computers configured to:
provide training examples made up of training measured data and associated training output variables;
subdivide a spatial region, which contains at least a portion of the locations indicated by the training measured data of a training example, into a grid made up of adjoining cells;
aggregate, for each cell of the adjoining cells, the values of the measured variables contained in the training measured data of the training example for all locations in the cell, to form values of the measured variables which relate to the cell;
map the aggregated values of the measured variables, by the neural network, on one or multiple output variables;
assess deviations of the output variables from the training output variables using a predefined cost function, which is composed in weighted form of contributions of individual cells of the grid, the weight of each contribution being a function of an occupancy of the corresponding cell with locations contained in the training measured data of the training example; and
optimize parameters, which characterize a behavior of the neural network, with a goal that upon further processing of training examples, the assessment by the cost function is expected to improve.
